(19) United States
(12) Patent Application Publication
(10) Pub. No.: US 2010/0115261 A1
(43) Pub. Date: May 6, 2010

(54) EXTENSIBLE SEAL MANAGEMENT FOR ENCRYPTED DATA

(75) Inventors: Richard F. Annicchiarico, Nashua, NH (US); David S. Kern, Billerica, MA (US); Robert J. Paganetti, Scituate, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/266,470

(22) Filed: Nov. 6, 2008

(51) Int. Cl. H04L 9/00

(52) U.S. Cl. 713/150

(57) ABSTRACT

Embodiments of the present invention address deficiencies of the art in respect to seal list management in decrypting encrypted data and provide a method, system and computer program product for extensible seal management for encrypted data. In an embodiment of the invention, a method for extensible seal management for encrypted data can include identifying multiple different seal hints of different seal hint formats for different seals in a seal list associated with encrypted data and selecting from amongst the multiple different seal hints, seal hints of a recognizable seal hint format. The method also can include filtering the seals in the seal list according to the selected seal hints and attempting decryption of the filtered seals with a decryption key specified by the selected seal hints to decrypt one of the filtered seals in order to reveal a bulk key. Finally, the method can include decrypting the encrypted data with the bulk key.

### BACKGROUND OF THE INVENTION

1. Field of the Invention

The present invention relates to data encryption, and more particularly to seal management for encrypted data.

2. Description of the Related Art

Information technologists view network security to be a top priority in the deployment and management of information technology resources. While network security often involves such diverse aspects of the enterprise which range from routing gateways onto the public network to virus detection and remediation, securing the privacy and confidentiality of data remains a bedrock mission for the network security specialist. Generally, data security relates directly to the science of cryptography as applied to data of interest.

In cryptography, security can be achieved through encryption. Encryption involves the conversion of clear-text data, such as a document or message, into encrypted data that appears to be a meaningless and random sequence of bits known as cipher text. A cryptographic algorithm, also known as cipher, is the mathematical function that processes plain text input to produce cipher text. All modern ciphers use keys together with plain text as the input to produce cipher text. In this regard, a key is a value that works with a cryptographic algorithm to produce specific cipher text. The same or a different key can be supplied to the decryption function to recover plain text from cipher text. As applied to the encryption of data such as a document or message, the key used to encrypt the data often is referred to as a “bulk key”.

After data has been encrypted with a bulk key, a recipient of the encrypted data must be able to obtain the bulk key in order to decrypt the data. When one bulk key protects data to be accessed by multiple recipients as in the case of a published document or message, the bulk key cannot be given directly to all recipients without incurring security risk. Therefore, typically the bulk key itself is encrypted for each recipient, using a separate key individually associated with the recipient. Each encrypted instance of the bulk key is termed a “seal”. A seal often is stored with the data itself, so that the seal will be available when needed by the intended recipient to access the bulk key during decryption of the data.

To the extent that data is to be distributed at once to multiple different recipients, all of the seals for the bulk key for the data can be collected in a seal list and appended to the data so that the encrypted data and the bulk key to decrypt the data are disposed in one package. As such, to decrypt the data, the computing application used to render the data must know a priori the format of the seal list in order to read the seal list, and to locate a usable seal within the seal list in an efficient manner. For a small seal list, a brute force method of simply trying each seal until successfully locating the correct seal can be adequate. However, for a voluminous seal list, it is not desirable to simply try by brute force to decrypt each seal with each and every key available to the recipient.

Consequently, each seal usually contains a hint as to which key was used to encrypt the seal. The hint then can be used to quickly assess whether the recipient is likely to successfully use a particular seal in the seal list. For many applications, the public key of the recipient is the key used to encrypt the bulk key. Accordingly, the hint will be most effective when the hint identifies the seal in the seal list that is related to the public key of the recipient. For example, one possible hint is related to the creation date of the public key of the recipient. Yet, frequently recipients share the same creation data for their respective public keys. Notwithstanding, adding additional hint mechanisms such as hash values of the public key not only can be difficult for most applications, but to do so introduces incompatibilities between applications where the applications do not provide a way to incorporate the new hint mechanisms. Further, as new versions of the application incorporate new hint mechanisms, accessing archived messages may not be supported by the new hint mechanisms.

### BRIEF SUMMARY OF THE INVENTION

Embodiments of the present invention address deficiencies of the art in respect to seal list management in decrypting encrypted data and provide a novel and non-obvious method, system and computer program product for extensible seal management for encrypted data. In an embodiment of the invention, a method for extensible seal management for encrypted data can include identifying multiple different seal hints of different seal hint formats for different seals in a seal list associated with encrypted data and selecting from amongst the multiple different seal hints, a seal hint of a recognizable seal hint format. The method also can include filtering the seals in the seal list according to the selected seal hints and attempting decryption of the filtered seals with a decryption key specified by the selected seal hint to decrypt one of the filtered seals in order to reveal a bulk key. Finally, the method can include decrypting the encrypted data with the bulk key.

In another embodiment of the invention, a data processing system can be configured for extensible seal management for encrypted data. The system can include an extensible seal management module coupled to data decryption logic for a data processing application executing in a host computing platform. The module can include program code enabled to identify multiple different seal hints of different seal hint formats for different seals in a seal list associated with encrypted data and to select from amongst the multiple different seal hints, a seal hint of a recognizable seal hint format. The program code of the module further can be enabled to filter the seals in the seal list according to the selected seal hint, and to attempt decryption of the filtered seals with a decryption key specified by the selected seal hints to decrypt one of the filtered seals in order to reveal a bulk key for use by the data decryption logic in decrypting the encrypted data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for extensible seal management for encrypted data;

FIG. 2 is a schematic illustration of a data processing system configured for extensible seal management for encrypted data; and,

FIG. 3 is a flow chart illustrating a process for extensible seal management for encrypted data.

### DETAILED DESCRIPTION OF THE INVENTION

Embodiments of the present invention provide a method, system and computer program product for extensible seal management for encrypted data. In accordance with an embodiment of the present invention, a seal list format for seals encrypting a bulk key for encrypted data can be extended to include different hints for different seals associated with different recipients of the encrypted data. Upon receipt of the encrypted data, unrecognized hint types for seals in a seal list for the encrypted data can be ignored and one or more recognized hint types can be processed to filter the seal list. Thereafter, each seal in the filtered seal list can be processed to attempt to decrypt the bulk key. Finally, the bulk key can be used to decrypt the encrypted data.

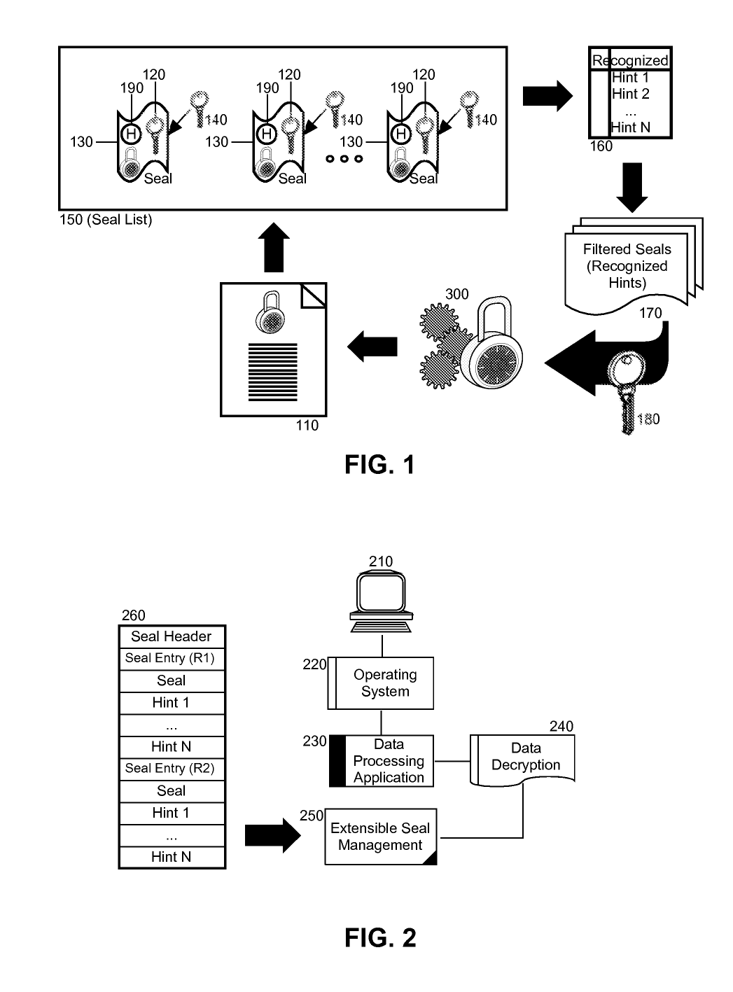

In further illustration, FIG. 1 is a pictorial illustration of a process for extensible seal management for encrypted data. As shown in FIG. 1, encrypted data 110, for example an encrypted document or an encrypted message, can be associated with a seal list 150 of different seals 130 for different data recipients. Each of the seals 130 can include an encrypted form of a bulk key 120 for the encrypted data 110 and each of the seals 130 can be encrypted with a seal key 140 corresponding one of the data recipients. Each of the seals 130 in the seal list 150 can include different hints 190 for each of the seal keys 140 for each of the data recipients. Each of the different hints 190 can be of a different hint format, such as a creation date of a requisite one of the seal keys 140 for decrypting a corresponding one of the seals 130, or a hash of a requisite one of the seal keys 140 for decrypting a corresponding one of the seals 130. As one example, the requisite key 180 can be a private key associated with a data recipient that corresponds to a public key used to encrypt the bulk key 120 in a respective one of the seals 130.

Hints 190 of a format unrecognizable to extensible seal management logic 300 can be ignored; however, one or more hints 190 of a format recognizable to the extensible seal management logic 300 can be grouped into a list 160 and used to produce a filtered list of seals 170 with corresponding hints 190 of a recognizable format included in the list 160. The filtered list of seals 170 in turn can be used by extensible seal management logic 300 to identify and obtain a requisite key 180 corresponding to one of the seal keys 140 in order to decrypt the bulk key 120 necessary to decrypt the encrypted data 110. In this way, though the format of different ones of the hints 160 can change over time, the extensible seal management logic 300 can identify and obtain the requisite key 180 by ignoring unrecognized seal formats and addressing only recognized seal hint formats in the list 160 to generate the filtered list of seals 170. Each seal in the filtered list of seals 170 in turn can be used in an attempt to identify the requisite key 180 subsequent to which the requisite key 180 can be used to successfully decrypt the bulk key 120.

The process described in connection with FIG. 1 can be implemented in a data processing system configured for extensible seal management. In yet further illustration, FIG. 2 is a schematic illustration of a data processing system configured for extensible seal management for encrypted data. The system as shown in FIG. 1 can include a host computing platform 210 supporting the execution of an operating system 220. The operating system 220 in turn can host the operation of a data processing application 230, such as a document editor or messaging client. The data processing application 230 can include data decryption logic 240 configured to decrypt encrypted data and the data decryption logic 240 can be coupled to an extensible seal management module 250.

The extensible seal management module 250 can include program code enabled to process a seal list 260 according to hints for each seal in the seal list 260 of a format recognized by the extensible seal management module 250. In contrast, the program code of the extensible seal management module 250 can be enabled to ignore hints for each seal in the seal list 260 of a format not recognized by the extensible seal management module 250. More particularly, the seal list 260 can include a different seal entries for different seals for different recipients (R1, R2 . . . RN) of corresponding encrypted data. Each seal in the seal list 260 can include different hints, each of a different format, each referencing a key necessary to decrypt the seal to reveal a bulk key for decrypting the encrypted data.

By way of example, the seal list can include a seal header and multiple different seal entries. The seal header can include data pertinent to the entire seal list such as a number of seal entries in the seal list and a number of hint extensions in different hint formats in addition to a base format for a base hint for the seal list. The seal header also can include an initial sequence of fixed data items describing the base format of the base hint for the seal list. Additional data items can be included subsequent to the initial sequence, each of the additional data items describing a different hint format of a different hint for the seal list. A descriptor also can be provided in the seal header in connection with each different hint format describing both a type and usage for a corresponding hint.

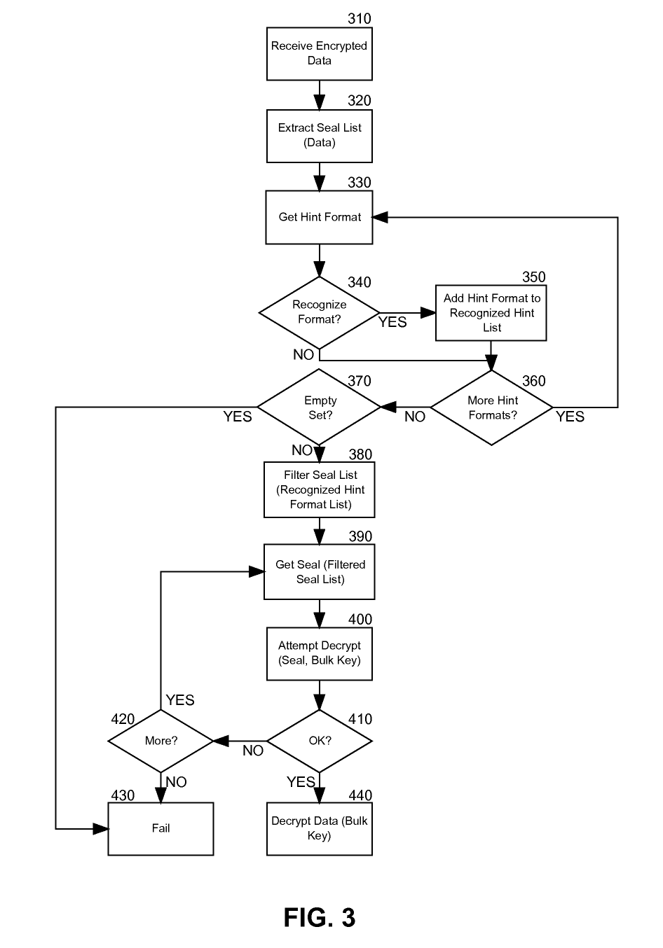

The process exercised by the extensible seal management module 250 of FIG. 2 will be understood in connection with the flow chart of FIG. 3. Beginning in block 310 of FIG. 3, encrypted data can be received for decryption and processing in a data processing application. In block 320, a seal list can be extracted in association with the encrypted data and in block 330, a first hint format from the seal list can be identified. In decision block 340, it can be determined whether or not the format of the hint is recognizable. If so, in block 350 the hint format can be added to a list of recognized hint formats. Thereafter, in decision block 360 it can be determined if additional hint formats remain to be considered for the seal list. If so, a next hint format from the seal list can be identified and processed through block 330.

In decision block 360, if it is determined that no additional hint formats remain to be considered for the seal list, in decision block 370 it can be determined whether at least one recognizable hint format has been included in the list of recognized hint formats. If not, the process can fail in block 430. Otherwise, in block 380, the seals in the seal list can be filtered to only those seals with corresponding hint conformant with at least one hint format in the list of recognized hint formats.

Subsequently, in block 390 a first seal in the filtered set of seals can be retrieved and in block 400, a corresponding key for any one of the hints for the retrieved seal that conforms to a recognizable format can be applied to the retrieved seal in order to decrypt the seal to obtain a bulk key to the encrypted data. In decision block 410, if the corresponding key cannot decrypt the seal, in decision block 420, it can be determined whether or not additional seals remain to be processed. If not, in block 430 the attempt to decrypt the seal can fail. Otherwise, a next seal in the discrete set can be retrieved in block 390 and in block 400, the corresponding key can be applied to the retrieved seal. In decision block 410, if the corresponding key is able to decrypt the seal into a bulk key, in block 440 the bulk key can be applied to the encrypted data in order to decrypt the encrypted data.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for extensible seal management for encrypted data, the method comprising:
identifying multiple different seal hints of different seal hint formats for different seals in a seal list associated with encrypted data;
selecting from amongst the multiple different seal hints, a seal hint of a recognizable seal hint format;
filtering the seals in the seal list according to the selected seal hint;
attempting decryption of the filtered seals with a decryption key specified by the selected seal hint to decrypt one of the filtered seals in order to reveal a bulk key; and,
decrypting the encrypted data with the bulk key.

2. The method of claim 1, wherein the encrypted data is an encrypted document.

3. The method of claim 1, wherein the encrypted data is an encrypted message.

4. The method of claim 1, wherein the seal hint of a recognizable seal hint format is a creation date of a decryption key requisite for decrypting a corresponding one of the seals in the seal list.

5. The method of claim 1, wherein the seal hint of a recognizable seal hint format is a hash of a decryption key requisite for decrypting a corresponding one of the seals in the seal list.

6. The method of claim 1, wherein selecting from amongst the multiple different seal hints, a seal hint of a recognizable seal hint format, further comprises ignoring seal hints of an unrecognizable seal hint format.

7. A data processing system configured for extensible seal management for encrypted data, the system comprising:
an extensible seal management module coupled to data decryption logic for a data processing application executing in a host computing platform, the module comprising program code enabled to:
identify multiple different seal hints of different seal hint formats for different seals in a seal list associated with encrypted data,
select from amongst the multiple different seal hints, a seal hint of a recognizable seal hint format,
filter the seals in the seal list according to the selected seal hint, and,
attempt decryption of the filtered seals with a decryption key specified by the selected seal hint to decrypt one of the filtered seals in order to reveal a bulk key for use by the data decryption logic in decrypting the encrypted data.

8. The system of claim 7, wherein the encrypted data is an encrypted document.

9. The system of claim 7, wherein the encrypted data is an encrypted message.

10. The system of claim 7, wherein the seal hint of a recognizable seal hint format is a creation date of a decryption key requisite for decrypting a corresponding one of the seals in the seal list.

11. The system of claim 7, wherein the seal hint of a recognizable seal hint format is a hash of a decryption key requisite for decrypting a corresponding one of the seals in the seal list.

12. A computer program product comprising a computer usable medium embodying computer usable program code for extensible seal management for encrypted data, the computer program product comprising:
computer usable program code for identifying multiple different seal hints of different seal hint formats for different seals in a seal list associated with encrypted data;
computer usable program code for selecting from amongst the multiple different seal hints, a seal hint of a recognizable seal hint format;
computer usable program code for filtering the seals in the seal list according to the selected seal hint;
computer usable program code for attempting decryption of the filtered seals with a decryption key specified by the selected seal hint to decrypt one of the filtered seals in order to reveal a bulk key; and,
decrypting the encrypted data with the bulk key.

13. The computer program product of claim 12, wherein the encrypted data is an encrypted document.

14. The computer program product of claim 12, wherein the encrypted data is an encrypted message.

15. The computer program product of claim 12, wherein the seal hint of a recognizable seal hint format is a creation date of a decryption key requisite for decrypting a corresponding one of the seals in the seal list.

16. The computer program product of claim 12, wherein the seal hint of a recognizable seal hint format is a hash of a decryption key requisite for decrypting a corresponding one of the seals in the seal list.

17. The computer program product of claim 12, wherein the computer usable program code for selecting from amongst the multiple different seal hints, a seal hint of a recognizable seal hint format, further comprises computer usable program code for ignoring seal hints of an unrecognizable seal hint format.
